(19) United States
(12) Patent Application Publication
(10) Pub. No.: US 2020/0061546 A1
(43) Pub. Date: Feb. 27, 2020

(54) WATER FILTRATION

(71) Applicant: The University of Manchester, Manchester (GB)

(72) Inventors: Rahul Raveendran-Nair, Manchester (GB); Jijp Abranbam, Manchester (GB); Andre Geim, Manchester (GB)

(21) Appl. No.: 16/465,503

(22) PCT Filed: Nov. 30, 2017
(86) PCT No.: PCT/GB2017/053619

§ 371 Date: May 30, 2019

(30) Foreign Application Priority Data
Nov. 30, 2016 (GB) 16203560.4

(51) Int. Cl. B01D 71/02; B01D 61/02; B01D 65/00; B01D 67/00; B01D 69/02; B01D 69/14

(52) U.S. Cl. CPC B01D 71/021; B01D 61/027; B01D 65/003; B01D 67/0079; B01D 2313/04; B01D 69/02; B01D 69/141; B01D 71/024; B01D 2313/02; B01D 67/0088

(57) ABSTRACT

The invention relates to graphene oxide laminate membranes that are physically constrained. The physical constraint limits the size of the capillaries in the laminate, allowing them to be tailored to a particular application. This invention also relates to methods of purifying water using said membranes and methods of making said membranes.

The invention relates to graphene oxide laminate membranes that are physically constrained. This invention also relates to methods of purifying water using said membranes and methods of making said membranes.

### BACKGROUND

The removal of solutes from water finds application in many fields.

This may take the form of the purification of water for drinking or for watering crops or it may take the form of the purification of waste waters from industry to prevent environmental damage. Examples of applications for water purification include: the removal of salt from sea water for drinking water or for use in industry; the purification of brackish water; the removal of radioactive ions from water which has been involved in nuclear enrichment, nuclear power generation or nuclear clean-up (e.g. that involved in the decommissioning of former nuclear power stations or following nuclear incidents); the removal of environmentally hazardous substances (e.g. halogenated organic compounds, heavy metals, chlorates and perchlorates) from industrial waste waters before they enter the water system; and the removal of biological pathogens (e.g. viruses, bacteria, parasites, etc) from contaminated or suspect drinking water.

In many industrial contexts (e.g. the nuclear industry) it is often desirable to separate dangerous or otherwise undesired solutes from valuable (e.g. rare metals) solutes in industrial waste waters in order that the valuable solutes can be recovered and reused or sold.

Graphene is believed to be impermeable to all gases and liquids. Membranes made from graphene oxide are impermeable to most liquids, vapours and gases, including helium. However, an academic study has shown that, surprisingly, graphene oxide membranes having a thickness around 1 μm composed of oxygen rich functionalities are permeable to water even though they are impermeable to helium. These graphene oxide sheets allow unimpeded permeation of water (10¹⁰ times faster than He) (Nair et al. Science, 2012, 335, 442-444). Such GO laminates are particularly attractive as potential filtration or separation media because they are easy to fabricate, mechanically robust and offer no principal obstacles towards industrial scale production.

Sun et al (Selective Ion Penetration of Graphene Oxide Membranes; ACS Nano 7, 428 (2013)) describes the selective ion penetration of graphene oxide membranes in which the graphene oxide is formed by oxidation of wormlike graphite. The membranes are freestanding in the sense that they are not associated with a support material. The resultant graphene oxide contains more oxygen functional groups than graphene oxide prepared from natural graphite and laminates formed from this material have a wrinkled surface topography. Such membranes differ from those of the present invention because they do not show fast ion permeation of small ions and also demonstrate a selectivity which is substantially related to chemical and electrostatic interactions rather than size of ions.

This study found that sodium salts permeated quickly through GO membranes, whereas heavy metal salts permeated much more slowly. Copper sulphate and organic contaminants, such as rhodamine B are blocked entirely because of their strong interactions with GO membranes. According to this study, ionic or molecular permeation through GO is mainly controlled by the interaction between ions or molecules with the functional groups present in the GO sheets. The authors comment that the selectivity of the GO membranes cannot be explained solely by ionic-radius based theories. They measured the electrical conductivities of different permeate solutions and used this value to compare the permeation rates of different salts. The potential applied to measure the conductivities can affect ion permeation through membranes.

Other publications (Y. Han, Z. Xu, C. Gao. Adv. Funct. Mater. 23, 3693 (2013); M. Hu, B. Mi. Environ. Sci. Technol. 47, 3715 (2013); H. Huang et al. Chem. Comm. 49, 5963 (2013)) have reported filtration properties of GO laminates and, although results varied widely due to different fabrication and measurement procedures, they reported appealing characteristics including large water fluxes and notable rejection rates for certain salts. Unfortunately, large organic molecules were also found to pass through such GO filters. The latter observation is disappointing and would considerably limit interest in GO laminates as molecular sieves. In this respect, we note that the emphasis of these studies was on high water rates that could be comparable to or exceed the rates used for industrial desalination. Accordingly, a high water pressure was applied and the GO membranes were intentionally prepared as thin as possible, 10-50 nm thick. It may be that such thin stacks contained holes and cracks (some may appear after applying pressure), through which even large organic molecules could penetrate.

Recently, Joshi et al have described the use of graphene oxide laminate membranes as size exclusion membranes (R. K. Joshi et al., 2014, Science, 343, 752-754; see also WO2015/075451). These membranes selectively excluded solutes having a hydration radius greater than about 4.5 Å. allowing solutes with a smaller radius to pass through. Molecular permeation through GO membranes is believed to occur along graphene channels that develop between GO sheets, and their sieving properties are defined by the interlayer spacing, d, which depends on the humidity of the surrounding. Immersing GO membranes in liquid water leads to intercalation of 2-3 layers of water molecules between individual GO sheets, which results in swelling and d≈13.5 Å. The effective pore-size of 9 Å in these swollen membranes (excluding the space occupied by carbon atoms) is larger than a typical size of hydrated ions and restricts possible uses of GO for size-exclusion based ion sieving. Unfortunately, many solutes which might be desirable to be able to filter out, including for example NaCl, have hydration radii which are below 4.5 Å and are not effectively excluded from passing through the membrane.

WO2016/ 189320 (PCT/GB2016/051539) describes how graphene oxide laminate membranes could be modified, either by including graphene flakes or by including cross-linking agents, to improve the level of exclusion of solutes that have hydration radii which are below 4.5 Å, e.g. NaCl.

### BRIEF SUMMARY OF THE DISCLOSURE

In a first aspect of the invention is provided a water filtration membrane, said membrane comprising a graphene oxide (GO) laminate comprising a plurality of graphene oxide flakes the planes of which are orientated parallel to one another, said GO laminate having a first pair of oppositely disposed faces which are oriented parallel to the planes of the plurality of graphene oxide flakes, said GO laminate also having a second pair of oppositely disposed faces which are oriented perpendicular to the planes of the plurality of graphene oxide flakes and a third pair of oppositely disposed faces which are oriented perpendicular to the planes of the plurality of graphene oxide flakes; wherein the GO laminate membrane is enclosed by a first encapsulating material that covers each of the first pair of faces of the GO laminate and each of the second pair of oppositely disposed faces of the GO laminate and wherein the third pair of oppositely disposed faces are either not enclosed or are enclosed by a second encapsulating material, said second encapsulating material being porous.

In a second aspect of the invention is provided a method of reducing the amount of one or more solutes in an aqueous mixture to produce a liquid depleted in said solutes, the method comprising:

a) contacting a first face of the third pair of faces of the GO laminate of a water filtration membrane of the first aspect with the aqueous mixture comprising the one or more solutes;
b) recovering the liquid depleted in said solutes from or downstream from a second face of the third pair of faces of the of the GO laminate.

In an third aspect of the invention is provided a filtration device comprising a membrane of the first aspect of the invention. The filtration device may be a filter assembly or it may be a removable and replaceable filter for use in a filter assembly.

In a fourth aspect of the invention is provided a method of producing a membrane of the first aspect, the method comprising:

a) providing a graphene oxide (GO) laminate;
b) subjecting the GO laminate to an atmosphere having a predetermined relative humidity ; and
c) enclosing each of the first pair and second pair of faces of the GO laminate membrane with the first encapsulating material while maintaining the relative humidity of the atmosphere at the predetermined level to provide the membrane of the first aspect.

When graphene oxide (GO) laminates are used to filter aqueous mixtures, the capillaries that form between and around the graphene oxide sheets expand. This expansion means that the smallest ions that can effectively be excluded by prior are those having a hydration radius greater than 4.5 Å. The inventors have found, however, that by encapsulating GO laminates, the expansion of the pores which usually occurs on hydration of GO laminates is limited. This in turn can allow the membrane to exclude smaller ions than would be excluded with GO laminates which were not encapsulated, i.e. ions with hydration radii below 4.5 Å. Additionally, or alternatively, it can allow the membrane to be more effective at excluding those smaller ions that can pass through non-encapsulated GO membranes.

The capillary size of the hydrated membrane is the d-spacing minus the thickness of the graphene sheet (typically about 3.4 Å). Thus hydrated non-encapsulated GO membranes with a d-spacing of between 12 and 13 have a capillary size of between about 9 and 9.5 and a size exclusion cut off of about 4.5.

As the exclusion limit of the membrane is directly related to the d-spacing of the hydrated laminate, the size exclusion selectivity of these classes of membranes can be tuned by selecting appropriate conditions (e.g. of humidity) at which a graphene oxide laminate has the desired d-spacing and encapsulating the membrane at that d-spacing. When the encapsulated GO laminate is hydrated, e.g. in use, the d-spacing cannot expand beyond the size that it was at the time when the GO laminate was encapsulated. Thus, the d-spacing of the encapsulated GO laminate may be selected dependent on the size of the ions which are being filtered.

The membranes of the invention exhibit improved rejection of certain salts (e.g. NaCl) relative to GO laminate membranes which are not encapsulated.

The inventors have found that by encapsulating the GO laminates in an atmosphere having a specific relative humidity, they can tune the size of the d-spacing.

### Membranes

The first encapsulating material may be a polymer. Examples include epoxy resins and polyurethane resins.

The first encapsulating material may be a metal or metal oxide. Examples include aluminium, copper, Al₂O₃, SiO₂, etc.

The first encapsulating material will typically have a tensile strength of about 30 mPa or greater. The first encapsulating material may have a tensile strength of about 40 mPa or greater. High tensile strength improves the longevity of the membrane.

Where the first encapsulating material is a polymer, it will typically have a water absorption of about 1.5% or lower after 30 days at 20 ° C. The first encapsulating material may have water absorption of about 1.25% or lower after 30 days at 20 ° C. The first encapsulating material may have water absorption of about 1% or lower after 30 days at 20 ° C. Low water absorption improves the longevity of the membrane.

Where the first encapsulating material is a polymer, it will typically be formed from a resin having a viscosity of about 10 Pa.s or lower. The first encapsulating material be formed from a resin having a viscosity of about 2 Pa.s or lower. The first encapsulating material is formed from a resin having a viscosity of about 1 Pa.s or lower. For the absence of doubt, where the resin is formed before use by mixing multiple components (e.g. a resin that is formed shortly before use by combining a pre-resin with a hardener) the viscosity mentioned in this paragraph is the viscosity of the mixed resin. Low viscosity facilitates formation of the encapsulated membrane.

Where the first encapsulating material is a polymer, it may be transparent. This facilitates visual checking of the GO laminate.

The graphene oxide flakes in the laminate may have the same length and width as the laminate—thus each layer of the graphene oxide laminate may comprise a single flake of graphene oxide. More usually, however, each layer of the graphene oxide laminate comprises a plurality of graphene oxide flakes.

It may be that greater than 50% by weight (e.g. greater than 75% by weight, greater than 90% or greater than 98%) of the graphene oxide flakes have a diameter of less than 10 μm. It may be that greater than 50% by weight (e.g. greater than 75% by weight, greater than 90% or greater than 98%) of the graphene oxide flakes have a diameter of greater than 50 nm. It may be that greater than 50% by weight (e.g. greater than 75% by weight, greater than 90% or greater than 98%) of the graphene oxide flakes have a diameter of less than 5 μm. It may be that greater than 50% by weight (e.g. greater than 75% by weight, greater than 90% or greater than 98%) of the graphene oxide flakes have a diameter of greater than 100 nm. It may be that greater than 50% by weight (e.g. greater than 75% by weight, greater than 90% or greater than 98%) of the graphene oxide flakes have a diameter of less than 2 μm. It may be that greater than 50% by weight (e.g. greater than 75% by weight, greater than 90% or greater than 98%) of the graphene oxide flakes have a diameter of less than 1 μm. It may be that greater than 50% by weight (e.g. greater than 75% by weight, greater than 90% or greater than 98%) of the graphene oxide flakes have a diameter of less than 500 nm. It may be that greater than 50% by weight (e.g. greater than 75% by weight, greater than 90% or greater than 98%) of the graphene oxide flakes have a diameter of greater than 500 nm.

It may be that greater than 50% by weight (e.g. greater than 75% by weight, greater than 90% or greater than 98%) of the graphene oxide has a thickness of from 1 to 10 atomic layers. It may be that greater than 50% by weight (e.g. greater than 75% by weight, greater than 90% or greater than 98%) of the graphene oxide has a thickness of from 1 to 5 molecular layers. Thus, it may be that greater than 50% by weight (e.g. greater than 75% by weight, greater than 90% or greater than 98%) of the graphene oxide has a thickness of from 1 to 3 molecular layers. It may be that greater than 50% by weight (e.g. greater than 75% by weight, greater than 90% or greater than 98%) of the graphene oxide is single layer graphene oxide.

The laminate may comprise graphene flakes, distributed through the graphene oxide flakes. It may be that the graphene flakes represent from 0.5 wt % to 10 wt % of the flakes of which the graphene oxide laminate is comprised. It may be that the graphene flakes represent from 1 wt % to 7.5 wt % of the flakes of which the graphene oxide laminate is comprised. It may be that the graphene flakes represent from 2 wt % to 6 wt % of the flakes of which the graphene oxide laminate is comprised. The inclusion of graphene can improve the flux of water through the membranes.

The graphene flakes may be monolayer graphene flakes. They may be few-layer (i.e. 2-10 atomic layers, e.g. 3-7 atomic layers) graphene flakes. The graphene may be a reduced graphene oxide or partially oxidized graphene. Preferably, however, it is pristine graphene. The graphene may be pristine graphene with small holes in it. The defects in reduced graphene oxide or partially oxidized graphene or holes in pristine graphene can lead to higher fluxes.

It may be that greater than 50% by weight (e.g. greater than 75% by weight, greater than 90% or greater than 98%) of the graphene flakes have a diameter of less than 10 μm. It may be that greater than 50% by weight (e.g. greater than 75% by weight, greater than 90% or greater than 98%) of the graphene flakes have a diameter of greater than 50 nm. It may be that greater than 50% by weight (e.g. greater than 75% by weight, greater than 90% or greater than 98%) of the graphene flakes have a diameter of less than 5 μm. It may be that greater than 50% by weight (e.g. greater than 75% by weight, greater than 90% or greater than 98%) of the graphene flakes have a diameter of greater than 100 nm. It may be that greater than 50% by weight (e.g. greater than 75% by weight, greater than 90% or greater than 98%) of the graphene flakes have a diameter of less than 1 μm. It may be that greater than 50% by weight (e.g. greater than 75% by weight, greater than 90% or greater than 98%) of the graphene flakes have a diameter of less than 500 nm.

It may be that greater than 50% by weight (e.g. greater than 75% by weight, greater than 90% or greater than 98%) of the graphene has a thickness of from 1 to 10 atomic layers. It may be that greater than 50% by weight (e.g. greater than 75% by weight, greater than 90% or greater than 98%) of the graphene has a thickness of from 1 to 5 molecular layers. Thus, it may be that greater than 50% by weight (e.g. greater than 75% by weight, greater than 90% or greater than 98%) of the graphene has a thickness of from 1 to 3 molecular layers. It may be that greater than 50% by weight (e.g. greater than 75% by weight, greater than 90% or greater than 98%) of the graphene is single layer graphene.

The size exclusion limit depends in part on the average spacing between the GO flakes, i.e. the height of the capillaries. This average spacing can be measured indirectly, using x-ray diffraction, as the d-spacing, which can be calculated from the x-ray diffraction peaks using Bragg's law. The d-spacing of a laminate is effectively the sum of the thickness of the GO flake and the distance between the GO flakes. The observed d-spacing will be an average, the standard deviation of which will depend on the width of the x-ray diffraction peaks. The width of the x-ray diffraction peaks indicates how much variation there is in the thickness of the GO flake and the distance between the GO flakes.

It may be that when hydrated, the encapsulated GO laminate has a d-spacing in the range 6 Å to 10 Å. may be that when hydrated the encapsulated GO laminate has a d-spacing in the range 6.4 Å to 9.8 Å. The d-spacing of the hydrated graphene oxide laminate may be 10 Å or below. The d-spacing of the hydrated graphene oxide laminate may be 9 Å or below. The d-spacing of the hydrated graphene oxide laminate may be below 8 Å or below. The d-spacing of the hydrated graphene oxide laminate may be 7 Å or below.

The GO flakes which form the membranes may have been prepared by the oxidation of natural graphite. It may be that the graphene oxide flakes of which the laminate is comprised have an average oxygen:carbon weight ratio in the range of from 0.2:1.0 to 0.5:1.0, e.g. from 0.25:1.0 to 0.45:1.0. Preferably, the flakes have an average oxygen:carbon weight ratio in the range of from 0.3:1.0 to 0.4:1.0.

The flakes of graphene oxide which form the laminate of the invention are usually monolayer graphene oxide. However, it is possible to use flakes of graphene oxide containing from 2 to 10 atomic layers of carbon in each flake. These multilayer flakes are frequently referred to as “few-layer” flakes. Thus the laminate may be made entirely from monolayer graphene oxide flakes, from a mixture of monolayer and few-layer flakes, or from entirely few-layer flakes. Ideally, the flakes are entirely or predominantly, i.e. more than 75% w/w, monolayer graphene oxide.

The graphene oxide laminate may comprise a cross-linking agent. Cross-linking agents can improve the flux of water through the membranes or make it easier to handle or form the laminate. Inclusion of a crosslinking agent can also allow the use of a less rigorous method of confining the laminate, e.g. the use of a less strong encapsulating material. A cross linking agent is a substance which bonds with GO flakes in the laminate. The cross linking agent may form hydrogen bonds with GO flakes or it may form covalent bonds with GO flakes. Examples (which are included in some embodiments of the invention but which may be specifically excluded from other embodiments of the invention) include diamines (e.g. ethyl diamine, propyl diamine, phenylene diamine), polyallylamines and imidazole. Without wishing to be bound by theory, it is believed that these are examples of crosslinking agents which form hydrogen bonds with GO flakes. Other examples include borate ions and polyetherimides formed from capping the GO with polydopamine. Examples of appropriate cross linking systems can be found in Tian et al, (Adv. Mater. 2013, 25, 2980-2983), An et al (Adv. Mater. 2011, 23, 3842-3846), Hung et al (Cross-linking with Diamine monomers to Prepare Composite Graphene Oxide-Framework Membranes with Varying d-Spacing; Chemistry of Materials, 2014) and Park et al (Graphene Oxide Sheets Chemically Cross-Linked by polyallylamine; J. Phys. Chem. C; 2009).

The crosslinking agent may be a polymer. The polymer may be interspersed throughout the membrane. It may occupy the spaces between graphene oxide flakes, thus providing interlayer crosslinking. Examples (which are included in some embodiments of the invention but which may be specifically excluded from other embodiments of the invention) include PVA (see for example Li et al Adv. Mater. 2012, 24, 3426-3431), poly(4-styrenesulfonate), Nafion, carboxymethyl cellulose, Chitosan, polyvinyl pyrrolidone, polyaniline etc. A preferred polymer is poly(2-acrylamido-2-methyl-1-propanesulfonic acid. It may be that the polymer is water soluble. Alternatively, it may be that the polymer is not water soluble.

The cross-linking agent may be a charged polymer, e.g. one which comprises sulfonic acids or other ionisable functional groups. Exemplary charged polymers include poly(4-styrenesulfonate), Nafion and poly(2-acrylamido-2-methyl-1-propanesulfonic acid.

The cross-linking agent (e.g. polymer or charged polymer) may be present in an amount from about 0.1 to about 50 wt %, e.g. from about 5 to about 45 wt %. Thus, the GO laminate may comprise from about 2 to about 25 wt % cross-linking agent (e.g. polymer or charged polymer). The GO laminate may comprise up to about 20 wt % cross-linking agent (e.g. polymer or charged polymer).

The GO laminates may comprise other inorganic materials, e.g. other two dimensional materials, such as hBN, mica. The presence of mica, for example, can slightly improve the mechanical properties of the GO laminate.

It may be that all six faces of the laminate are enclosed by an encapsulating material that is porous. Thus, it may be that the first encapsulating material and the second encapsulating material are the same.

Preferably, however, the first encapsulating material that encloses the first pair of faces and the second pair of faces is more usually non-porous. The third pair of oppositely disposed faces are not encapsulated by the non-porous material. It may be that the third pair of oppositely disposed faces are enclosed by a second material that is porous. Alternatively, it may be that the third pair of oppositely disposed faces are not enclosed.

The porous material should be sufficiently porous that it does not impede the passage of water but the pores should not be so small that flakes of graphene oxide and/or graphene can enter the pores.

It may be that, if present, the porous material comprises an inorganic material. Thus, the porous material may be a ceramic. The porous material may be alumina, zeolite, or silica. In one embodiment, the porous material is alumina. Zeolite A can also be used. Ceramic membranes have also been produced in which the active layer is amorphous titania or silica produced by a sol-gel process.

It may be that, if present, the porous material is a polymeric material. Examples include PES, PTFE, PVDF or polycarbonate (e.g. Cyclopore™). In an embodiment, the porous material may comprise a polymer. In an embodiment, the polymer may comprise a synthetic polymer. These can be used in the invention. Alternatively, the polymer may comprise a natural polymer or modified natural polymer. Thus, the polymer may comprise a polymer based on cellulose. The polymer support may be derived from a charged polymer such as one which contains sulfonic acids or other ionisable functional groups.

It may be that, if present, the porous material comprises a carbon monolith.

The GO laminate may be generally cuboid.

The length of the laminate may be from 10 μm to 5 mm. The length of the laminate may be from 100 μm to 3 mm.

The thickness of the laminate may be greater than 10 μm. The thickness of the laminate may be up to 1 cm, e.g up to 1 mm.

It may be that the thickness of the encapsulating material is greater than 1 μm. It may be that the thickness of the encapsulating material is at least the thickness of the laminate.

### Method of Water Filtration

In the second aspect of the invention is provided a method of reducing the amount of one or more solutes in an aqueous mixture to produce a liquid depleted in said solutes, the method comprising:

a) contacting a first face of the third pair of faces of the GO laminate of a water filtration membrane of the first aspect with the aqueous mixture comprising the one or more solutes;
b) recovering the liquid depleted in said solutes from or downstream from a second face of the third pair of faces of the of the GO laminate and/or recovering a liquid enriched in said solutes from or downstream from the first face of the third pair of faces of the GO laminate.

One difference of the methods of the invention relative to the prior art is that the aqueous mixture being filtered is passed along the length of the graphene oxide laminate, in a direction parallel to the orientation of the graphene oxide flakes, rather than through the graphene oxide laminate from one face to another in a direction perpendicular to the orientation of the graphene oxide flakes. Methods of removing solutes from water with encapsulated GO laminates produce more consistent results when the aqueous mixture passes through the GO laminate in this direction.

The method may also comprise recovering a liquid enriched in said solutes from or upstream from the first face of the third pair of faces.

The solutes which are depleted in the liquid have a hydration radius below a specific size exclusion limit. It may be that the size exclusion limit is in the range of from about 3.0 Å to about 4.5 Å. It may be that the size exclusion limit is in the range of from about 3.0 Å to about 4.25 Å. It may be that the size exclusion limit is in the range of from about 3.0 Å to about 4.0 Å.

In certain embodiments, the method is a process of selectively reducing the amount of a first set of one or more solutes in an aqueous mixture without significantly reducing the amount of a second set of one or more solutes in the aqueous mixture to produce a liquid depleted in said first set of solutes but not depleted in said second set of solutes. In these embodiments, the or each solute of the first set has a radius of hydration greater than the size exclusion limit and the or each solute of the second set has a radius of hydration less than the size exclusion limit.

It may be that the method is continuous. Thus, steps a) and b) may be carried out simultaneously or substantially simultaneously. Steps a) and b) may also be carried out iteratively in a continuous process to enhance enrichment or iteratively in a batch process.

It may be that the aqueous mixture is permitted to pass through the membrane by diffusion and/or it may be that a pressure is applied. Preferably, pressure is applied.

Preferably, no electrical potential is applied across the membrane. In principle, an electrical potential could be applied to modify the transport of ions through the membrane.

The term “solute” applies to both ions and counter-ions, and to uncharged molecular species present in the solution. Once dissolved in aqueous media a salt forms a solute comprising hydrated ions and counter-ions. The uncharged molecular species can be referred to as “non-ionic species”. Examples of non-ionic species are small organic molecules such as aliphatic or aromatic hydrocarbons (e.g. toluene, benzene, hexane, etc), alcohols (e.g. methanol, ethanol, propanol, glycerol, etc), carbohydrates (e.g. sugars such as sucrose), and amino acids and peptides. The non-ionic species may or may not bind with water through hydrogen bonds. As will be readily apparent to the person skilled in the art, the term ‘solute’ does not encompass solid substances which are not dissolved in the aqueous mixture. Particulate matter will not pass through the membranes of the invention even if the particulate is comprised of ions with small radii.

The term “hydration radius” refers to the effective radius of the molecule when solvated in aqueous media.

The reduction of the amount one or more selected solutes in the solution which is treated with the GO membrane of the present invention may entail entire removal or each selected solute. Alternatively, the reduction may not entail complete removal of a particular solute but simply a lowering of its concentration. The reduction may result in an altered ratio of the concentration of one or more solutes relative to the concentration of one or more other solutes. In cases in which salt is formed from one ion having a hydration radius of larger than the size exclusion limit and a counter-ion with a hydration radius below the size exclusion limit, neither ion will pass through the membrane of the invention because of the electrostatic attraction between the ions. Thus, for example, if an NaCl solution were passed through a membrane having a size exclusion limit of 3.5 Å, the amount of both the Na+ ions (hydration radius: 3.58 Å) and the Cl− ions (hydration radius: 3.32 Å) would be reduced, even though the Cl⁻ ions have a hydration radius below the size exclusion limit.

The precise value of the size exclusion limit for any given membrane may vary depending on application. For example, the inventors have shown that a d-spacing of 9.8 Å is sufficient to remove magnesium ions, whereas removal of lithium ions requires a d-spacing of below 9 Å and removal of sodium ions requires a d-spacing below 7.4 Å. The separation of Mg²⁺ ions and Na⁺ ions can be achieved even at the widest 9.8 Å capillary. In the region around the size exclusion limit, the degree of transmission decreases by orders of magnitude and consequently the effective value of the size exclusion limit depends on the amount of transmission of solute that is acceptable for a particular application.

The method may involve a plurality of membranes. These may be arranged in parallel (to increase the flux capacity of the process/device) or in series (where a reduction in the amount of one or more solute is achieved by a single membrane but that reduction is less than desired).

The one or more solutes can be ions and/or they could be neutral organic species, e.g. sugars, hydrocarbons etc. Where the solutes are ions they may be cations and/or they may be anions.

In certain preferred embodiments, the solutes are Na⁺ ions and/or Cl⁻ ions. Thus the method may be a method of desalination (i.e. a method of reducing the amount of NaCl in an aqueous mixture).

### Method of Making Physical Constrained Membranes

In the fourth aspect of the invention is provided a method of producing a membrane of the first aspect, the method comprising:

a) providing a graphene oxide (GO) laminate;
b) subjecting the GO laminate to an atmosphere having a predetermined relative humidity; and
c) enclosing each of the first pair and second pair of faces of the GO laminate membrane with the first encapsulating material while maintaining the relative humidity of the atmosphere at the predetermined level to provide the membrane of the first aspect.

Step (c) may comprise enclosing all six faces of the GO laminate with the first encapsulating material while maintaining the relative humidity of the atmosphere at the predetermined level. In this case, the method further may comprise removing the first encapsulating material from each of the third pair of faces to provide the membrane of the first aspect.

By selecting the relative humidity at which the GO laminate is encapsulated, the inventors have found that the d-spacing of the encapsulated laminate can be controlled.

Thus, a GO laminate encapsulated at a relative humidity of about 0% has a d-spacing of about 6.4 Å. A GO laminate encapsulated at a relative humidity of about 12% has a d-spacing of about 7.4 Å. A GO laminate encapsulated at a relative humidity of about 33% has a d-spacing of about 7.9 Å. A GO laminate encapsulated at a relative humidity of about 75% has a d-spacing of about 8.6 Å. A GO laminate encapsulated at a relative humidity of about 84% has a d-spacing of about 9.0 Å. A GO laminate encapsulated at a relative humidity of about 100% has a d-spacing of about 9.8 Å.

Thus, it may be that the GO laminate that is formed has a d-spacing below about 9 Å and the relative humidity is less than 84%. It may be that the GO laminate that is formed has a d-spacing below about 8 Å and the relative humidity is less than 30%. It may be that the GO laminate that is formed has a d-spacing below about 7 Å and the relative humidity is less than 5%.

The relative humidity can be controlled using standard salt solutions (see Greenspan et al.; Humidity fixed points of binary saturated aqueous solutions; J. Res. Natl. Bur. Stand. Sect. A; 81, 89-96, 1977; and Rockland; Saturated salt solutions for static control of relative humidity between 5 and 40 C; Anal. Chem. 32, 1375-1376; 1960)). Alternatively, the humidity could be controlled by filling the vessel in which the laminate is with humidity controlled air.

The method may comprise covering the third pair of faces with a second encapsulating material that is porous.

Providing the GO laminate membrane may comprise forming the GO laminate membrane.

a) providing a suspension of graphite oxide flakes in an aqueous medium;
b) subjecting the flakes in the aqueous medium to energy to obtain an aqueous suspension comprising graphene flakes and graphene oxide flakes;
c) optionally removing any graphite oxide and/or undesired few-layered graphene oxide flakes from the suspension; and
d) filtering the suspension to provide a graphene oxide laminate.

The suspension of graphite oxide flakes may also comprise graphite flakes. In this case optional step (c), if present, includes removing any graphite flakes and/or any undesired few-layered graphene flakes from the suspension.

The energy applied in step (b) may be sonic energy. The sonic energy may be ultrasonic energy. It may be delivered in using a bath sonicator or a tip sonicator. Alternatively the energy may be a mechanical energy, e.g. shear force energy or grinding. The particles may be subjected to energy (e.g. sonic energy) for a length of time from 15 min to 1 week, depending on the properties and proportions (flake diameter and thickness) desired. The particles may be subjected to energy (e.g. sonic energy) for a length of time from 1 to 4 days.

Where the desired laminate also comprises cross-linking agents, these will be present in the aqueous medium prior to filtration. They may be present in the suspension of graphite oxide or they may be added after step b) or, if present, step c).

The term ‘aqueous medium’ as used to describe the third aspect of the invention can be understood to mean a liquid which contains water, e.g. which contains greater than 20% by volume water. The aqueous medium may contain more than 50% by volume water, e.g. more than 75% by volume water or more than 95% by volume water. The aqueous medium may also comprise solutes or suspended particles and other solvents (which may or may not be miscible with water). The aqueous medium may comprise additives which may be ionic, organic or amphiphillic. Examples of such additives include surfactants, viscosity modifiers, pH modifiers, iconicity modifiers, and dispersants. It may be however that the aqueous medium consists essentially of water, graphite and graphite oxide and optionally one or more cross-linking agents

The step of reducing the amount of multilayered particles in the suspension may comprise using a centrifuge.

In an fourth aspect of the invention is provided a filtration device comprising a membrane of the first aspect of the invention. The filtration device may be a filter assembly or it may be a removable and replaceable filter for use in a filter assembly.

Where not mutually exclusive, any of the embodiments described above in relation to the first aspects of the invention apply equally to the third aspect of the invention

### BRIEF DESCRIPTION OF THE DRAWINGS

Embodiments of the invention are further described hereinafter with reference to the accompanying drawings, in which:

FIG. 1 shows for physically confined GO membranes (PCGO) (a) Schematic illustrating the direction of ion/water permeation along graphene planes. (b) Photograph of a PCGO membrane glued into a rectangular slot within a plastic disk of 5 cm in diameter.

Inset: Photo of the PCGO stack before it was placed inside the slot. Scale bar, 5 mm. (c) Optical micrograph of the cross-sectional area marked by a red rectangle in (b), which shows 100-μm-thick GO laminates (black) embedded in epoxy. The latter is seen in light yellow with dark streaks because of surface scratches. (d) SEM image from the marked region in (c). Scale bar, 1 μm. (e) Humidity dependent d found using X-ray diffraction (inset). The case of liquid water is also shown. Error bars: standard deviation using multiple measurements and different samples.

FIG. 2 shows (a) Permeation rates through PCGO membranes with different interlayer distances. The salts used: KCl, NaCl, LiCl, CaCl₂ and MgCl₂. Dashed lines: Guides to the eye indicating a rapid cutoff in salt permeation, which is dependent on d. Grey area: Below-detection limit for our measurements lasting 5 days, with arrows indicating the limits for individual salts. The horizontal line indicates our detection limit for Cl⁻. Above the latter limit, we found that both cations and anions permeated in stoichiometric quantities. (b) Permeation rates for K⁺ and Na⁺ depend exponentially on the interlayer distance (left axis). Water permeation varied only linearly with d (blue squares, right axis). The dotted lines are best fits. The horizontal error bars correspond to a half-width for the diffractions peaks in FIG. 1e. (c) Temperature dependence for K⁺ permeation. Dotted lines: Best fits to the Arrhenius behaviour. Inset: Energy barriers for various ions and different d, as found in our molecular dynamic simulations.

FIG. 3 illustrates the step-by-step procedure in the fabrication of PCGO membrane.

FIG. 4 shows the permeation experiment set-up: (a) Experimental set-up showing Teflon made feed and permeate compartments used for the ion permeation experiments. Membranes were clamped between two O-rings and then fixed between feed and permeate compartments to provide a leak tight environment for the permeation experiments. (b) Cross-sectional view of the feed/permeate compartment showing O-ring (4.2 cm outer diameter) arrangement for sealing the membranes.

FIG. 5 shows ion permeation through a PCGO membrane with an interlayer spacing of 9.8 Å from the feed compartment with 1 M aqueous solution of KCl. The inset shows K⁺ ion permeation rate as a function of concentration of the feed solution.

FIG. 6 shows water permeation through PCGO membranes. Weight loss for a container sealed with PCGO membranes with different interlayer spacing. Inset shows the PCGO membrane sample used for the pressure filtration experiment (diameter of the disc is 51 mm).

FIG. 7 shows a snapshot of the simulation cell used in the free energy barrier simulations.

FIG. 8 shows (a) The decrease in n₁ (solid line) and n₂ (dashed line) as the ions enter a channel with an interlayer spacing of 7 Å. (b) n₁ for K⁺ entering channels with interlayer spacing ranging from 7 to 11 Å.

FIG. 9 shows the dehydration of Mg²⁺. Mg²⁺ with the first hydration shell entering the 7 Å graphene channel at x=1.6, 1.8 and 2.0 nm in the simulation box (left to right).

FIG. 10 shows ion diffusion through sub-nm channels. Diffusion coefficient of K⁺ ion in water for interlayer spacing ranging from 7 Å to 11 Å.

FIG. 11 shows a membrane of the invention.

### DETAILED DESCRIPTION

The thickness of the laminate is used herein to mean the distance between the first pair of oppositely disposed faces. The width of the laminate is used herein to mean the distance between the second pair of oppositely disposed faces. The length of the laminate is used herein to mean the distance between third pair of oppositely disposed faces.

The term ‘enclosed by’ is used throughout this specification to mean that the respective faces are substantially entirely covered by the encapsulated material.

The present invention involves the use of graphene oxide laminates. The graphene oxide laminates of the invention comprise a plurality of individual graphene oxide flakes, in which the flakes are predominantly monolayer graphene oxide. Although the flakes are predominantly monolayer graphene oxide, it is within the scope of this invention that some of the graphene oxide is present as two- or few-layer graphene oxide. Thus, it may be that at least 75% by weight of the graphene oxide is in the form of monolayer graphene oxide flakes, or it may be that at least 85% by weight of the graphene oxide is in the form of monolayer graphene oxide flakes (e.g. at least 95%, for example at least 99% by weight of the graphene oxide is in the form of monolayer graphene oxide flakes) with the remainder made up of two- or few- layer graphene oxide. Without wishing to be bound by theory, it is believed that water and solutes pass through capillary-like pathways formed between the graphene oxide flakes by diffusion and that the specific structure of the graphene oxide laminates leads to the remarkable selectivity observed as well as the remarkable speed at which the ions permeate through the laminate structure. The flakes in the laminate are piled on top of one another and orientated parallel to one another to form a series of layers. The flakes are arranged randomly relative to one another and typically overlap. Thus, a central portion of any one flake may be situated directly over the edge of any other flake or it may be situated directly over the central portion of any other flake.

Graphene oxide flakes are two dimensional heterogeneous macromolecules containing both hydrophobic ‘graphene’ regions and hydrophilic regions with large amounts of oxygen functionality (e.g. epoxide, carboxylate groups, carbonyl groups, hydroxyl groups)

In one illustrative example, the graphene oxide laminates are made of impermeable functionalized graphene sheets that have a typical size L≈1 μm and the interlayer separation, d, sufficient to accommodate a mobile layer of water.

The solutes to be removed from aqueous mixtures in the methods of the present invention may be defined in terms of their hydrated radius. Below are the hydrated radii of some exemplary ions and molecules.

TABLE 1

| Ion/molecule | Hydrated radius (Å) |
|---|---|
| K⁺ | 3.31 |
| Cl⁻ | 3.32 |
| Na⁺ | 3.58 |
| CH₃COO⁻ | 3.75 |
| SO₄²⁻ | 3.79 |
| AsO₄³⁻ | 3.85 |
| CO₃²⁻ | 3.94 |
| Cu²⁺ | 4.19 |
| Mg²⁺ | 4.28 |
| propanol | 4.48 |
| glycerol | 4.65 |
| [Fe(CN)₆]³⁻ | 4.75 |
| sucrose | 5.01 |
| (PTS)⁴⁻ | 5.04 |
| [Ru(bipy)₃]²⁺ | 5.90 |
| Tl⁺ | 3.30 |
| Li⁺ | 3.82 |
| Rb⁺ | 3.29 |
| Cs⁺ | 3.29 |
| NH₄₊ | 3.31 |
| Be²⁺ | 4.59 |
| Ca²⁺ | 4.12 |
| Zn²⁺ | 4.30 |
| Ag⁺ | 3.41 |
| Cd²⁺ | 4.26 |
| Al³⁺ | 4.80 |
| Pb²⁺ | 4.01 |
| NO₃⁻ | 3.40 |
| OH— | 3.00 |
| H₃O⁺ | 2.80 |
| Br— | 3.30 |
| I— | 3.31 |

The hydrated radii of many species are available in the literature. However, for some species the hydrated radii may not be available. The radii of many species are described in terms of their Stokes radius and typically this information will be available where the hydrated radius is not. For example, of the above species, there exist no literature values for the hydrated radius of propanol, sucrose, glycerol and PTS⁴⁻. The hydrated radii of these species which are provided in the table above have been estimated using their Stokes/crystal radii. To this end, the hydrated radii for a selection of species in which this value was known can be plotted as a function of the Stokes radii for those species and this yields a simple linear dependence. Hydrated radii for propanol, sucrose, glycerol and PTS⁴⁻ were then estimated using the linear dependence and the known

Stokes radii of those species.

There are a number of methods described in the literature for the calculation of hydration radii. Examples are provided in ‘Determination of the effective hydrodynamic radii of small molecules by viscometry’; Schultz and Soloman; The Journal of General Physiology; 44; 1189-1199 (1963); and ‘Phenomenological Theory of Ion Solvation’; E. R. Nightingale. J. Phys. Chem. 63, 1381 (1959).

The term ‘aqueous mixture’ used to describe the second aspect of the invention refers to any mixture of substances which comprises at least 10% water by weight. It may comprise at least 50% water by weight and preferably comprises at least 80% water by weight, e.g. at least 90% water by weight. The mixture may be a solution, a suspension, an emulsion or a mixture thereof. Typically the aqueous mixture will be an aqueous solution in which one or more solutes are dissolved in water. This does not exclude the possibility that there might be particulate matter, droplets or micelles suspended in the solution. Of course, it is expected that the particulate matter will not pass through the membranes of the invention even if it is comprised of ions with small radii.

The graphene oxide or graphite oxide for use in this application can be made by any means known in the art. In a preferred method, graphite oxide can be prepared from graphite flakes (e.g. natural graphite flakes) by treating them with potassium permanganate and sodium nitrate in concentrated sulphuric acid. This method is called Hummers method. Another method is the Brodie method, which involves adding potassium chlorate (KClO₃) to a slurry of graphite in fuming nitric acid. For a review see, Dreyer et al. The chemistry of graphene oxide, Chem. Soc. Rev., 2010, 39, 228-240.

Individual graphene oxide (GO) sheets can then be exfoliated by dissolving graphite oxide in water or other polar solvents with the help of ultrasound, and bulk residues can then be removed by centrifugation and optionally a dialysis step to remove additional salts.

In a specific embodiment, the graphene oxide of which the graphene oxide laminates of the invention are comprised is not formed from wormlike graphite. Worm-like graphite is graphite that has been treated with concentrated sulphuric acid and hydrogen peroxide at 1000° C. to convert graphite into an expanded “worm-like” graphite. When this worm-like graphite undergoes an oxidation reaction it exhibits a higher increase the oxidation rate and efficiency (due to a higher surface area available in expanded graphite as compared to pristine graphite) and the resultant graphene oxide contains more oxygen functional groups than graphene oxide prepared from natural graphite. Laminates formed from such highly functionalized graphene oxide can be shown to have a wrinkled surface topography and lamellar structure (Sun et al,; Selective Ion Penetration of Graphene Oxide Membranes; ACS Nano 7, 428 (2013) which differs from the layered structure observed in laminates formed from graphene oxide prepared from natural graphite. Such membranes do not show fast ion permeation of small ions and a selectivity which is substantially unrelated to size (being due rather to interactions between solutes and the graphene oxide functional groups) compared to laminates formed from graphene oxide prepared from natural graphite.

The preparation of graphene oxide laminate supported on a porous membrane can be achieved using filtration, spray coating, casting, dip coating techniques, road coating, inject printing, or any other thin film coating techniques

For large scale production of supported graphene based membranes or sheets it is preferred to use spray coating, road coating or inject printing techniques. One benefit of spray coating is that spraying GO solution in water on to the porous support material at an elevated temperature produces a large uniform GO film.

Graphite oxide consists of micrometer thick stacked graphite oxide flakes (defined by the starting graphite flakes used for oxidation, after oxidation it gets expanded due to the attached functional groups) and can be considered as a polycrystalline material. Exfoliation of graphite oxide in water into individual graphene oxide flakes was achieved by the sonication technique followed by centrifugation at 10000 rpm to remove few layers and thick flakes. Graphene oxide laminates were formed by restacking of these single or few layer graphene oxides by a number of different techniques such as spin coating, spray coating, road coating and vacuum filtration.

Graphene oxide membranes according to the invention consist of overlapped layers of randomly oriented single layer graphene oxide sheets with smaller dimensions (due to sonication). These membranes can be considered as centimetre size single crystals (grains) formed by parallel graphene oxide sheets. Due to this difference in layered structure, the atomic structure of the capillary structure of graphene oxide membranes and graphite oxide are different. For graphene oxide membranes the edge functional groups are located over the non-functionalised regions of another graphene oxide sheet while in graphite oxide mostly edges are aligned over another graphite oxide edge. These differences unexpectedly may influence the permeability properties of graphene oxide membranes as compared to those of graphite oxide.

A layer of graphene consists of a sheet of sp²-hybridized carbon atoms. Each carbon atom is covalently bonded to three neighboring carbon atoms to form a ‘honeycomb’ network of tessellated hexagons. Carbon nanostructures which have more than 10 graphene layers (i.e. 10 atomic layers; 3.4 Å interlayer distance) generally exhibit properties more similar to graphite than to mono-layer graphene. Thus, throughout this specification, the term graphene is intended to mean a carbon nanostructure with up to 10 graphene layers. A graphene layer can be considered to be a single sheet of graphite.

In the context of this disclosure the term graphene is intended to encompass both pristine graphene (i.e. un-functionalised or substantially un-functionalised graphene) and reduced graphene oxide. When graphene oxide is reduced a graphene like substance is obtained which retains some of the oxygen functionality of the graphene oxide. It may be however that the term ‘graphene’ is excludes both graphene oxide and reduced graphene oxide and thus is limited to pristine graphene. All graphene contains some oxygen, dependent on the oxygen content of the graphite from which is it derived. It may be that the term ‘graphene’ encompasses graphene that comprises up to 10% oxygen by weight, e.g. less than 8% oxygen by weight or less than 5% oxygen by weight.

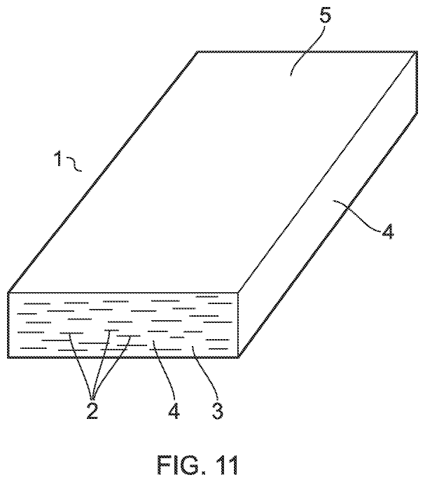

FIG. 11 depicts a simple membrane of the invention. The membrane 1 comprises a plurality of grahene oxide flakes 2 orientated parallel to one another to form a graphene oxide laminate 3. The laminate has three pairs of oppositely disposed faces. A first pair of oppositely disposed faces (e.g. 5) are orientated parallel to the planes of the graphene oxide flakes and a second and third pair of oppositely disposed faces (e.g. 3 and 4) are orientated perpendicular to the planes of the graphene oxide flakes. The first pair of oppositely disposed faces (e.g. 5) and the second pair of oppositely disposed faces (e.g. 4) are enclosed by a first encapsulating material. The third pair of oppositely disposed faces (e.g. 3) may not be enclosed (shown) or it may be enclosed by a porous material (not shown).

Throughout the description and claims of this specification, the words “comprise” and “contain” and variations of them mean “including but not limited to”, and they are not intended to (and do not) exclude other moieties, additives, components, integers or steps. Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, characteristics, compounds, chemical moieties or groups described in conjunction with a particular aspect, embodiment or example of the invention are to be understood to be applicable to any other aspect, embodiment or example described herein unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed.

The reader's attention is directed to all papers and documents which are filed concurrently with or previous to this specification in connection with this application and which are open to public inspection with this specification, and the contents of all such papers and documents are incorporated herein by reference.

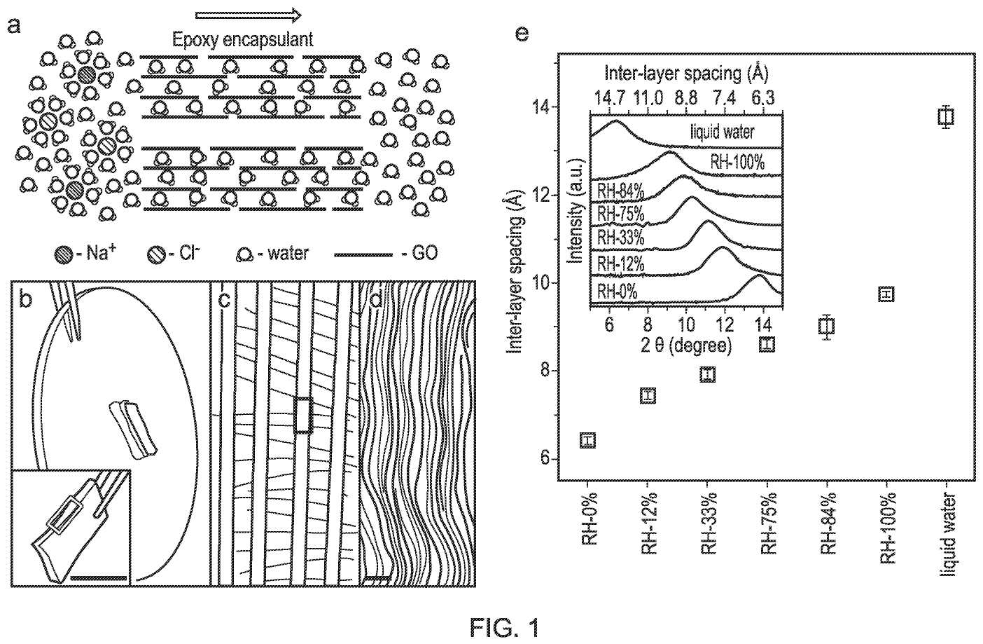

In this report, we investigate ion permeation through GO laminates with d controlled from ≈9.8 to ≈6.4 Å, which is achieved by physical confinement (FIG. 1a). Our results show that the changes in d dramatically alter ion selectivity due to dehydration effects whereas permeation of water molecules remains largely unaffected.

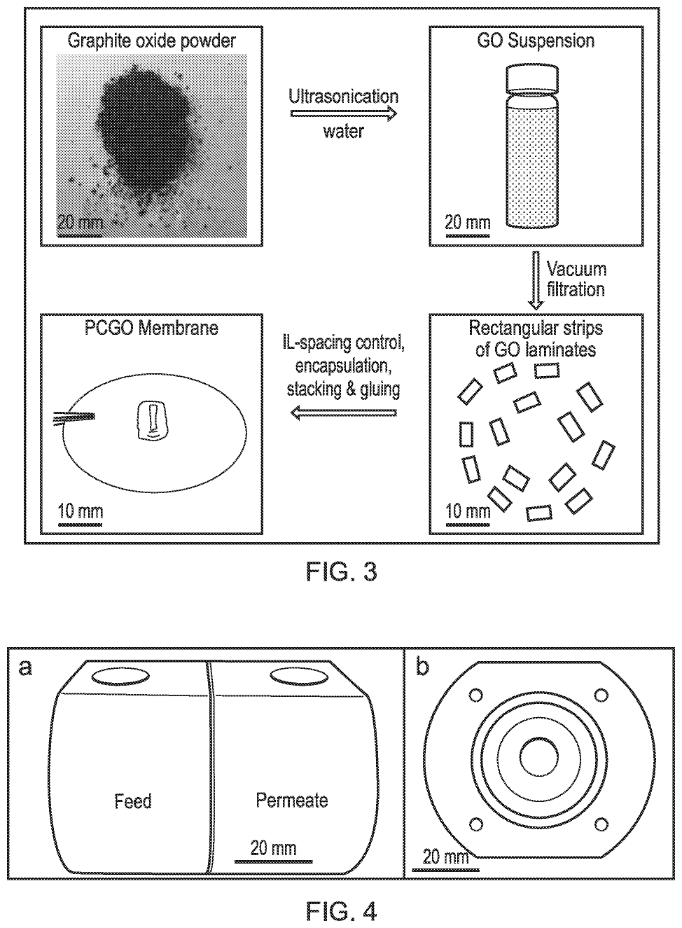

Thick (≈100 μm) GO laminates were prepared by vacuum filtration of aqueous GO solutions, as reported previously (Nair et al; Science; 335, 442-444, 2012). The laminates were cut into rectangular strips (4 mm×10 mm) and stored for one to two weeks at different relative humidities (RH), achieved using saturated salt solutions. The resulting interlayer spacing was measured by X-ray diffraction as shown in FIG. 1e and varied from ≈6.4 to 9.8 A with RH changing from zero to 100%. GO laminates soaked in liquid water showed d≈13.7±0.3 Å. All these values agree with previous reports, where the changes in d were attributed to successive incorporation of water molecules into various sites between GO sheets. Individual GO strips with desirable d were then encapsulated using Stycast epoxy as shown in FIGS. 1b,c to increase the available cross-section for filtration to ˜1 mm (see Methods and FIG. 3). The GO laminates, now embedded in the epoxy (FIG. 1c), are referred to as physically confined GO (PCGO) membranes because the epoxy mechanically restricts the laminate's swelling upon exposure to RH or liquid water (Methods). The stacks were glued into a slot made in either metal or plastic plate (FIG. 1b). Two sides of these PCGO membranes were then trimmed off to make sure that all the nanochannels are open (FIG. 1d) before carrying out permeation experiments, in which ions and water molecules permeates along the lamination direction as shown in FIG. 1a.

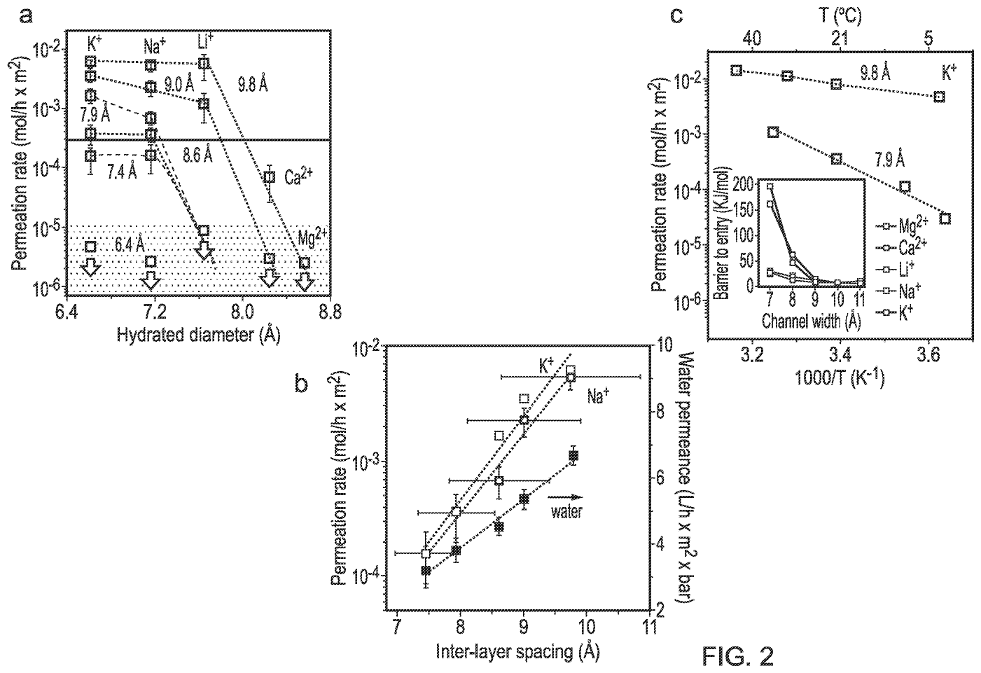

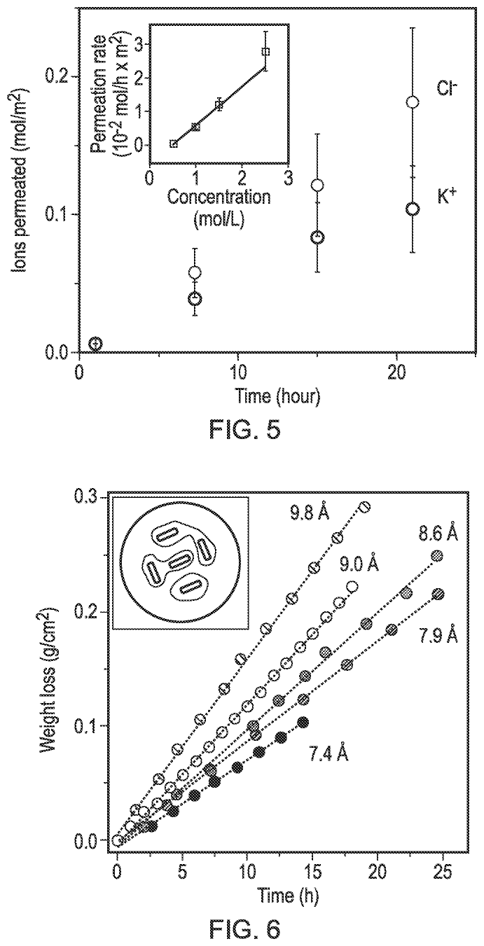

Our measurement setup was similar to the one previously reported (Joshi et al Science; 343; 752-754; 2014) and consisted of two Teflon compartments (feed and permeate) separated by a PCGO membrane (FIG. 4). The feed and permeate compartments were filled with 10 mL of a salt solution and deionized water, respectively. Quantitative analysis of anion and cation permeation between the compartments was carried out using ion chromatography (IC) and inductively coupled plasma atomic emission spectroscopy (ICP-AES), respectively. As expected, the ion concentration in the permeate compartment increased linearly with time and with increasing the concentration of the feed solution (detailed method section 1 below and FIG. 5). FIG. 2a summarises our results obtained for various ions permeating through PCGO membranes with different interlayer spacing. One can see that the permeation rates and the cutoff diameter for salt permeation decrease monotonically with decreasing d. Membranes with d≈6.4 Å showed no detectable ion concentration in the permeate even after five days. This further confirms that our PCGO membranes do not swell in water over time, despite a finite mechanical rigidity of the epoxy confinement. When plotted as a function of d, the observed ion permeation rates for Na⁺ and K⁺ showed an exponential dependence, decreasing by two orders of magnitude as d decreased from 9.8 to 7.4 Å (FIG. 2b). In contrast, the same PCGO membranes (detailed method section 2 below) showed only a little variation in permeation rates for water (FIG. 2b), decreasing by a factor of ≈2 for the same range of d. We note that this observation also rules out that the exponential changes in ion permeation could be related to partial clogging of graphene capillaries.

Both the observed relatively high permeation rates for Li⁺, K⁺ and Na⁺ for d>9 Å and their exponential decay for smaller d are surprising. Indeed, when considering steric (size-exclusion) effects, it is often assumed that ions in water occupy a rigid volume given by their hydrated diameters D. If this simplification was accurate, our PCGO membranes should not allow permeation of any common salt. Indeed, the effective pore size δ can be estimated as d−a, where a≈3.4 Å is the thickness of graphene. This yields δ≈6.4 Å for our largest capillaries (d≈9.8 Å), which is smaller than D for all the ions in FIG. 2a. This clearly indicates that ion sieving is not purely a geometric effect. On the other hand, if we assume that hydrated ions do fit into the nanochannels and their permeation is only limited by diffusion through water, the expected permeation rates should be significantly higher than those observed experimentally. For classical diffusion the permeation rate J is given by

J=Diff×ΔC×A_{eff}/L (1)

where ΔC is the concentration gradient across the membrane (1 M for the experiments in FIG. 2), A_{eff} the total cross-sectional area of nanocapillaries (≈3-8 mm²), L the diffusion length through the PCGO membrane (≈3 mm) and Diff is the diffusion coefficient for ions in water (typically, Diff ˜10⁻⁵ cm²/s; see supplementary section 6). Eq. (1) yields rates that are 2 to 4 orders magnitude higher than those shown in FIG. 2. This is in stark contrast to the sieving properties of GO laminates with d≈13.5 Å which showed an enhancement rather than suppression of ion diffusion. Clearly, the fact that the available space δ in PCGO laminates becomes smaller than D pushes the permeating hydrated ions into a new regime, distinct both from ions moving through wider nanocapillaties and from permeation behaviour of pure water. In the latter case, as shown in FIG. 2b, permeation rates for water molecules (whose size is smaller than δ) are 3 orders of magnitude higher than those estimated from the standard Hagen-Poiseuille equation using non-slip boundary conditions and the given dimensions of nanocapillaries (supplementary section 5). We attribute the enhancement to a large slip length of ˜60 nm for water on graphene.

To gain an insight into the mechanism of ion permeation through our membranes, we carried out permeation experiments at different temperatures, T (FIG. 2c). For both channel sizes, d=9.8 and d=7.9 Å, the permeation rates follow the Arrhenius equation, exp(−E/k_{B}T), i.e., show activation behaviour. Here E is the energy barrier and k_{B} the Boltzmann constant. The data yield E=72±7 and 20±2 kJ/mol for K⁺ ion permeation through PCGO membranes with d≈7.9 and 9.8 Å, respectively. The exponential dependence explains the fact that the observed ion diffusion rates are orders of magnitude smaller than those given by eq. (1), as at room temperature E>>k_{B}T for both channel sizes. The activation behaviour is also in agreement with recent theoretical predictions that nanopores with diameters <10 Å should exhibit significant energy barriers because of the required partial dehydration for ion's entry. Qualitatively, this mechanism can be explained as follows. In a bulk solution, water molecules stabilize ions by forming concentric hydration shells. For an ion to enter a channel with δ<D, some water molecules must be removed from the hydration shell. The higher the ion charge, the stronger it attracts water molecules. Accordingly, ions with larger hydration free energies and, therefore, ‘tougher’ water shells are expected to experience larger barriers for entry into atomic-scale capillaries and exponentially smaller permeation rates. Ions with weakly bound shells are easier to strip from their water molecules and allow entry into nanochannels. Similar arguments can be used to understand why water does not exhibit any exponential dependence on d: Water-water interactions are weak, so that it costs relatively little energy to remove surrounding water from water molecules entering the capillaries.

To support the proposed mechanism of dehydration-limited ion permeation for our PCGO membranes, we have performed MD simulations and calculated energy barriers for various ions entering graphene capillaries of different widths. As seen in FIG. 2c the activation energy E exhibits a sharp increase for d<9 Å and is considerably larger for divalent ions compared to monovalent ones, in agreement with our experiments and the above discussion (FIG. 2a). Quantitatively, the obtained E are of the same order of magnitude as those found experimentally; the discrepancy in exact values can be expected because realistic GO channels contain non-stoichiometric functionalities, rough edges, etc. which are difficult to model accurately.

### Methods—Summary

Preparation of GO membranes. The aqueous suspension of graphene oxide (GO) was prepared by dispersing millimeter sized graphite oxide flakes (purchased from BGT Materials Limited) in distilled water using bath sonication for 15 hours. The resulting dispersion was centrifuged 6 times at 8000 rpm to remove the multilayer GO flakes. Subsequently, free standing GO membranes of thickness≈100 μm were prepared by vacuum filtration of supernatant GO suspension through an Anodisc alumina membrane filter (0.2 μm pore size and a diameter of 47 mm, purchased from Millipore). As-prepared GO membranes were dried in an oven for 10 hours at 45° C. and cut into rectangular strips of dimension of 4 mm×10 mm (FIG. 2).

Tuning interlayer spacing in GO laminates. GO membranes with different IL spacing were prepared by storing them in a sealed container with different RH of 0%, 12%, 33%, 75%, 84% and 100%. To this end, we used saturated solutions of LiCl (12% RH), MgCl₂ (33%), NaCl (75%) and KCl (84%), which were prepared by dissolving excess amounts of salts in deionised water. A humidity meter was used inside the container to check that the salts provided the literature values of RH. As a zero humidity environment, we used a glove box filled with Ar and H₂O content below 0.5 ppm. 100% RH was achieved inside a sealed plastic container filled with a saturated water vapour at room T.

Analysis of the interlayer spacing. X-ray diffraction (XRD) measurements in the 2θ range of 5° to 15° (with a step size of 0.02° and recording rate of 0.1 s) were performed using a Bruker D8 diffractometer with Cu Kα radiation (λ=1.5406 Å). To collect an XRD spectrum from a GO membrane stored at a specific RH, we have created the same humid environment inside a specimen holder (Bruker, C79298A3244D83/85) and sealed it with the GO membrane. For the case of zero humidity, an airtight sample holder (Bruker, A100B36/B37) was used. All spectra were taken with a short scanning time to avoid possible hydration/dehydration of the GO membranes. From XRD analysis of the (001) reflection, IL d for 0%, 12%, 33%, 75%, 84% and 100% RH are found to be 6.4, 7.4, 7.9, 8.6, 9 and 9.8 Å respectively.

Fabrication of PCGO membranes. After achieving the desired d by using different humidity, each rectangular strip was immediately glued with Stycast 1266. This stack was then immediately transferred to the same humid environment (where the GO laminates were initially stored) for curing the epoxy overnight. Finally, the resulting stacks were glued into a slot in a plastic or copper plate as shown in FIG. 1. An epoxy layer present at the top and bottom cross sections of the glued stacks was carefully cleaved to produce a clean surface for permeation experiments. The cleaved cross-section was also checked under an optical microscope to remove any possible epoxy residues. The entire fabrication procedure is illustrated in FIG. 3. Swelling of the PCGO membranes upon exposure to liquid water was monitored by measuring the cross-sectional thickness of the membranes in an optical microscope immediately after and before performing the ion permeation experiments. The increase in thickness after the permeation experiments was found to be <1%, indicating the negligible swelling in PCGO membranes.

Permeation experiments. All permeation measurements were carried out using the set-up shown in FIG. 4, which consists of feed and permeate compartments made from Teflon. PCGO membranes incorporated plastic/metal plates (FIG. 3) were clamped between two O-rings and then fixed between the feed and permeate compartments to provide a leak tight environment for the permeation experiments. We filled the compartments with equal volumes (10 mL) of a salt solution (feed) and deionized water (permeate) to avoid any hydrostatic pressure due to different heights of the liquids. Permeation experiments at different temperatures (2-43° C.) were performed in a temperature controlled environmental chamber. The measurement-setup, feed and permeate solutions were equilibrated at each temperature before performing the experiment. Magnetic stirring was used in both compartments to avoid concentration polarization effects. Anion and cation concentrations in the permeate compartment caused by diffusion through PCGO membranes were accurately measured using ion chromatography (IC) and inductively coupled plasma atomic emission spectrometry (ICP-AES) techniques. Using the known volume of the permeate compartment, the concentrations allowed us to calculate the amount of ions that diffused into it.

### Methods—Detailed

### 1. Ion Permeation Through PCGO Membranes

Ion permeation through PCGO membranes was monitored as a function of concentration gradients and duration of the experiment. As an example, FIG. 5 shows the results for permeation of K⁺ and Cl− ions through PCGO membranes with an interlayer spacing of 9.8 Å. This increases linearly with time in a stoichiometric manner (within our experimental accuracy, as indicated in the figure), to preserve the charge neutrality in both compartments. The slope of such permeation vs time curves gives the permeation rate. As shown in the inset of FIG. 5, the permeation rate increases linearly with feed concentration, indicating a concentration driven diffusion process

### 2. Water Permeation Experiments

To understand the permeation of water molecules through PCGO membranes we have performed gravimetric measurements and pressure assisted water permeation experiments. Gravimetric measurements were carried out as reported previously (Nair et al. Science, 2012, 335, 442-444) inside a glove box environment (<0.5 ppm of H₂O) using a stainless steel container sealed with a PCGO membrane. Air-tight sealing was achieved by fixing the PCGO membrane glued plastic plate to a steel container using two rubber O-rings. In a typical experiment, the weight loss of a water filled container sealed with a PCGO membrane was monitored using computer-controlled balance (Denver Instrument SI-203 with a sensitivity of 1 mg). We have performed the weight loss experiments for the PCGO membranes with interlayer spacing, d, of 6.4, 7.4, 7.9, 8.6 and 9.8 Å to measure the water permeation rate as a function of interlayer spacing. No noticeable weight loss with an accuracy of 0.2 mg/h×cm2 was observed for the PCGO membranes with 6.4 Å interlayer spacing, indicating that the available free space of ≈3 Å is not sufficient for the permeation of water through graphene channels. However, the weight loss rates through PCGO membranes with interlayer spacings of 7.4, 7.9, 8.6 and 9.8 Å were measurable and significant: 7.4, 8.8, 10.4 and 15.4 mg/h×cm², giving a water permeance of 3.2, 3.8, 4.5 and 6.6 L/h×m²×bar, respectively.

In addition to the gravimetric measurements, we have also estimated the rate of liquid water permeation through PCGO membranes with an interlayer spacing of 7.9 Å using a Sterlitech HP4750 stirred cell. As shown in the inset of FIG. 6, the area of the membrane available for water permeation was increased by gluing multiple stacks of PCGO samples onto a stainless steel plate to collect a measurable amount of permeated water though PCGO membrane. The typical cross-sectional area and permeation length of the PCGO samples in this experiment was 0.3 cm² and 3 mm, respectively. The PCGO membranes assembly was then fixed inside the stirred cell using a rubber gasket to avoid any possible leakage in the experiment. We have used pure water as a feed solution and collected the water on other side by applying a pressure of 15 bar using a compressed nitrogen gas cylinder. Water permeance was found to be ≈0.5-1.0 L/h×m²×bar, which is roughly in agreement with the value obtained from the gravimetric measurements (≈4 times smaller). Due to the difficulties of fabricating samples with such large areas for pressure filtration, systematic filtration experiments with salt water were not performed.

Using the standard Hagen-Poiseuille equation with non-slip boundary conditions, we have estimated the water permeation rate through PCGO membranes with different interlayer spacings. Water flow through slit geometry can be described as

$$Q = \frac{1}{12 η} \frac{Δ P}{L} {δ}^{3} W ρ \qquad ( S1 )$$

where η is the viscosity of water (1 mPa.s), ΔP is driving pressure, L is the permeation length (3 mm), δ is the effective pore size, W is the lateral width of nanochannels (9 mm) and ρ is the density of water. The water flux through the PCGO membrane can be obtained as Q×S, where S is the area density of nano channels defined as A/W×d, where A is the area and d is the interlayer distance.

For PCGO membranes with an interlayer spacing of 7.4 and 9.8 Å, the estimated water flow rate per cm² is ≈2×10⁻³ mg/h and 6×10⁻³ mg/h respectively, which is three orders of magnitude lower than the experimentally observed water flow of 7.4 and 15.4 mg/h respectively. That is, water flow through PCGO membranes with interlayer spacings of 7.4 and 9.8 Å exhibits a flow enhancement, compared to the prediction from the Hagen-Poiseuille equation, by a factor of 4000 and 2000, respectively.

### 3. Molecular Dynamic Simulations

Molecular dynamics simulations (MD simulations) were used to calculate the free energy barriers for ions permeating into modelled graphene channels and the diffusion coefficients of the ions inside the channels. All simulations were performed using GROMACSS, version 5.0.4, in the NVT ensemble at a temperature of 298.15 K, maintained using the Nose-Hoover thermostat. The equations of motion were integrated using the leap-frog algorithm with a time-step of 2 fs. The intermolecular potential between particles i and j, Vij, was evaluated as the sum of a Lennard-Jones 12-6 term and a coulombic term,

$${V}_{ij} = 4 {ɛ}_{ij} [ {( \frac{{σ}_{ij}}{{r}_{ij}} )}^{12} - {( \frac{{σ}_{ij}}{{r}_{ij}} )}^{6} ] + \frac{{q}_{i} {q}_{j}}{4 π {ɛ}_{0} {r}_{ij}} \qquad ( S 2 )$$

for which the coulombic term was evaluated using the particle-mesh Ewald summation. In Equation S2, rᵢⱼ is the distance between the two particles with charges qi and qj and ϵ0 is the vacuum permittivity. In the 12-6 potential, the cross parameters for unlike atoms, σij and ϵij, were obtained using the Lorentz-Berthelot combining rules,

$${σ}_{ij} = \frac{( {σ}_{i} + {σ}_{j} )}{2} and {ɛ}_{ij} = {( {ɛ}_{i} {ɛ}_{j} )}^{\frac{1}{2}} \qquad ( S 3 )$$

where σᵢ and ϵᵢ are the parameters corresponding to an individual atom. Individual carbon atoms in the graphene sheets were modelled as rigid and with zero charge. The parameters for the carbon atoms were obtained from a study in which the water contact angle and adsorption energy were reproduced. The ion parameters were taken from studies in which the hydration free energy and hydrated radius of each ion were calculated and fitted to experimental quantities in bulk solution. The original parameterizations of both the carbon and ions were conducted using the SPC/E water model so we have used this model in our simulations. Non-bonded interactions were cutoff for rᵢⱼ<1.0 nm. The full set of non-bonded interaction parameters used in the simulations is given in Table 1.

TABLE 1
Non-bonded interaction parameters used in this work.

| i | σᵢ (nm) | εᵢ (kJ mol⁻¹) | qᵢ (e) |
|---|---|---|---|
| C | 0.3214 | 0.48990 | 0.000 |
| K⁺ | 0.4530 | 0.00061 | 1.000 |
| Na⁺ | 0.3810 | 0.00061 | 1.000 |
| Li⁺ | 0.2870 | 0.00061 | 1.000 |
| Ca²⁺ | 0.2410 | 0.94000 | 2.000 |
| Mg²⁺ | 0.1630 | 0.59000 | 2.000 |

The free energy barrier simulations were set up in a similar manner as described in much greater detail in our previous simulations. Briefly, this consists of five layers of graphene sheets, centered in the x-direction and stacked parallel in the z-direction, with an interlayer spacing of 7, 8, 9, 10 and 11 Å. The IL-space and adjoining reservoirs were filled with water molecules. A single ion (either Li+, Na+, K+, Mg2+ or Ca2+) was then swapped for one of the water molecules in the left-hand reservoir to generate the initial configuration (FIG. 7).

In order to obtain the energy barriers, a potential of mean force (PMF) describing the process of the ion entering the model membrane was generated for every ion and interlayer spacing. This was calculated using an umbrella sampling procedure involving 50 separate simulations, spanning the distance from the center of the reservoir (x=0.1 nm) to the center of the channel (x=2.5 nm), at 0.05 nm intervals. In each simulation, the position of the ion in the x direction was restrained using a harmonic potential with a force constant of 5000 kJ mol⁻¹ nm⁻². After an initial equilibration period of 1 ns, the PMF was generated from the force data obtained in a further 4 ns of simulation time, using the weighted histogram analysis method. The maximum energy along the PMF profile is equal to the barrier to permeation. In all cases, the observed barriers are positive, indicating that this process is energetically unfavorable. In general, the barrier height increases as the interlayer spacing decreases and, in the narrowest capillaries, the barriers are considerably larger for divalent ions than monovalent ions. Table 2 shows the free energy barriers for every ion obtained for different interlayer spacing.

TABLE 2
Free energy barriers to ion permeation into graphene
capillaries (kJ mol⁻¹). The number in brackets
is the uncertainty in the size of the barrier.

| | Interlayer Spacing (Å) | | | | |
|---|---|---|---|---|---|
| Ion | 7 | 8 | 9 | 10 | 11 |
| K⁺ | 27.5(0.6) | 17.4(0.3) | 10.8(0.3) | 5.6(0.2) | 5.6(0.3) |
| Na⁺ | 22.0(1.1) | 15.9(0.3) | 5.3(0.4) | 5.0(0.3) | 5.3(0.3) |
| Li⁺ | 24.7(1.3) | 8.5(0.3) | 4.5(0.4) | 3.2(0.3) | 1.8(0.2) |
| Ca²⁺ | 163.5(1.0) | 60.3(0.4) | 3.9(0.3) | 5.5(0.4) | 6.7(0.4) |
| Mg²⁺ | 197.8(2.2) | 44.3(0.5) | 4.6(0.3) | 3.9(0.4) | 5.4(0.4) |

The observed trends in barrier energy suggest that the size of the barrier is related to the hydration free energy. The higher charge on divalent ions results in stronger electrostatic attraction between the ion and the surrounding water, and the strength of these interactions is reflected in the magnitude of their experimental hydration free energies (see Table 3). Hence, ions with the most negative hydration free energies have the largest barriers to permeation, consistent with permeation data obtained experimentally.

TABLE 3
Experimental hydration free energy of different ions

| Ion | Hydration free energy (kJ/mol) |
|---|---|
| K⁺ | −321 |
| Na⁺ | −405 |
| Li⁺ | −515 |
| Ca²⁺ | −1592 |
| Mg²⁺ | −1922 |

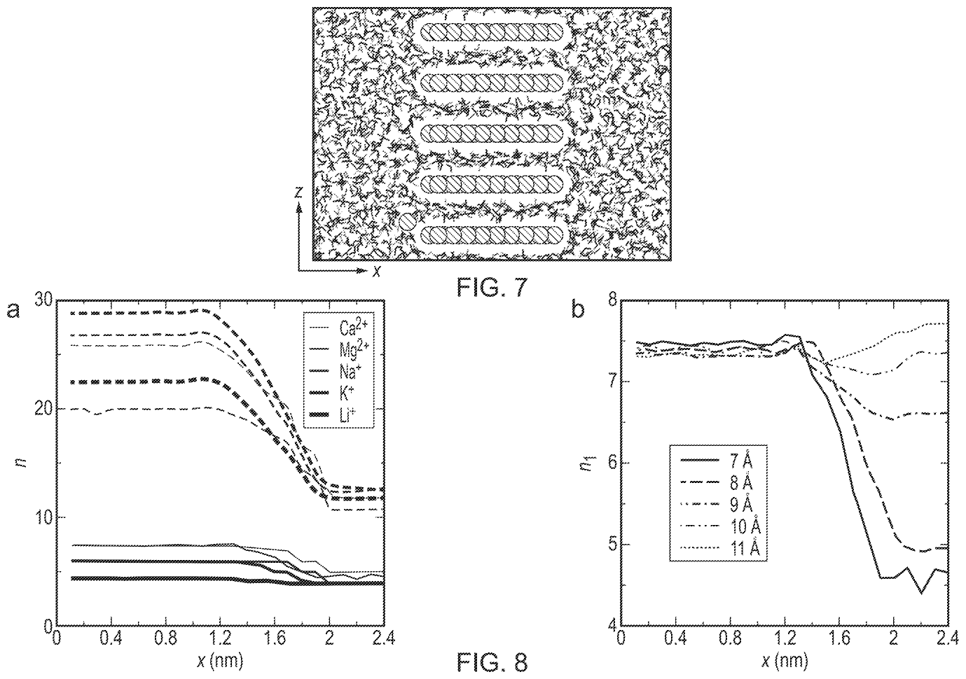

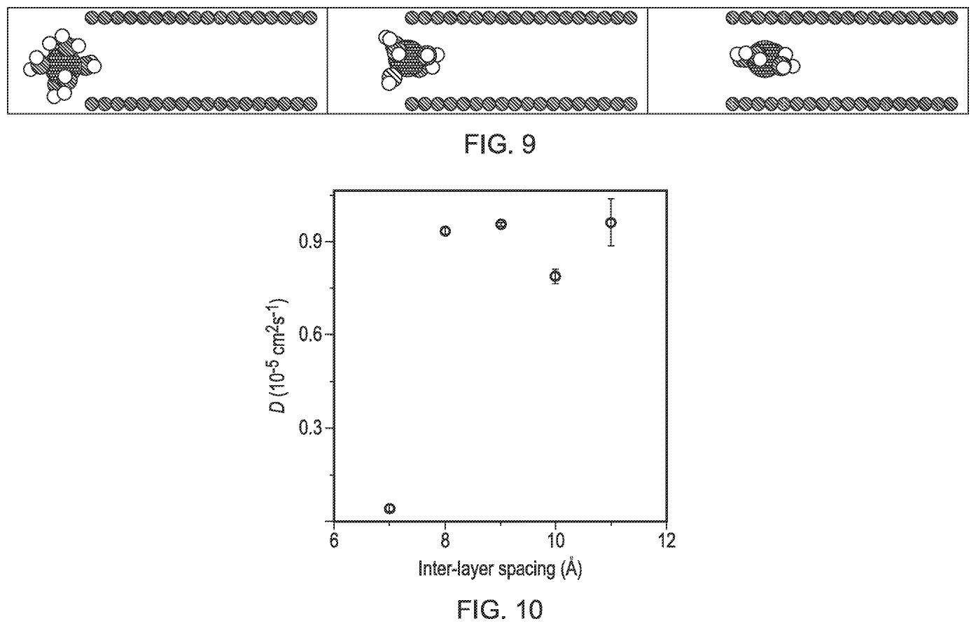

This ion dehydration effect was further investigated by analyzing the ion hydration numbers in each simulation window along the PMF profile (FIGS. 8 and 9). The hydration numbers for the first, n₁, and second, n₂, hydration shells, were calculated by taking the integral at the first and second minima in the ion-water radial distribution function. The FIG. 8a. shows that both n₁ and n₂ decrease as the ions move into a 7 Å channel. FIG. 8b. shows that, for K⁺, n₁ decreases to the greatest extent in the narrowest channel. There is a small increase in n₁ in the 11 Å channel, relative to bulk solution, and this appears to be because the K—O distance is commensurate with the peaks in the water density profile when K⁺ is in the center of the channel. We have discussed this observation in our previous work focusing on anion permeation. Typically, n₁ and n₂ are not integers, because they are averaged over the duration of the simulation and exchange of water molecules between the hydration shells and bulk solution is relatively frequent. However, for the most strongly hydrating ion, Mg²⁺, n₁ is always an integer. FIG. 9 shows the changes in the first hydration number of Mg²⁺ as the ion enters the channel with interlayer spacing of 7 Å, n₁=6.0 in bulk solution, n₁=5.0 at the entrance to the channel, and n₁=4.0 once in the center of the channel.

The primary hydration numbers of ions inside the channel were obtained from the last five simulation windows along the PMF profiles. Table 4 shows that n₁ decreases with interlayer spacing for all ions. Since the first hydration shell of the Li⁺ ion is very small, n₁ is only reduced slightly from 1.1 nm to 0.7 nm. However, for ions with larger ionic radii the decrease in n₁ is more significant. For example, for K⁺, n₁ decreases from 7.7 in a 11 Å channel to 4.7 in a 7 Å channel. Combined with the barriers in Table 2, this shows that ions with larger electrostatic interaction with the surrounding water molecules hold more water molecules to the primary hydration shell and shows larger energy barrier for permeation. It is interesting to note that for all of the cations there is a maximum in n₁ at some intermediate interlayer spacing. This appears to be the case when the effective interlayer spacing is commensurate with the distance from the ion to the first hydration shell with the ion in the center of the channel. We have also investigated even narrower interlayer spacing (<0.6 nm) but the channel does not retain any water molecules at this separation so the ions are required to completely dehydrate in order to enter into the membrane in our simulations.

TABLE 4
The number of water molecules in the first hydration shell, n₁.

| | Interlayer Spacing (Å) | | | | |
|---|---|---|---|---|---|
| Ion | 7 | 8 | 9 | 10 | 11 |
| K⁺ | 4.7 | 5.0 | 6.6 | 7.4 | 7.7 |
| Na⁺ | 4.0 | 4.4 | 5.6 | 5.7 | 5.7 |
| Li⁺ | 4.0 | 4.0 | 4.4 | 4.2 | 4.2 |
| Ca²⁺ | 5.0 | 7.5 | 7.9 | 7.3 | 7.2 |
| Mg²⁺ | 4.0 | 6.0 | 6.0 | 6.0 | 6.0 |

Separate simulations were performed to calculate the diffusion coefficient, D, of the K⁺ ion in narrow graphene channels. In the free energy simulations, an umbrella sampling constraint was required, which inherently restricts the movement of the ions, and when this restraint is removed the ions readily flow into the reservoir. Hence, the set up for calculating D involved graphene sheets with dimensions 6.14 nm×6.14 nm, again with interlayer spacing ranging from 7 to 11 Å. Unlike the free energy barrier calculations, the channels were periodic, providing an effectively infinitely long channel for ion diffusion. Water molecules were first added to the channel to achieve a density of 997.04 kg m⁻³, which is the density of bulk, unconfined water at 298.15 K and 1 atm. Then, a single water molecule was exchanged for the ion of interest. Extended simulation runs of 100 ns were used to calculate the mean squared displacement of the ion, and this was used to obtain D the from the Einstein relation

[symbol]

rᵢ(t₀+t)−rᵢ(t₀)|² [symbol] =6Dt (S4)

where rᵢ is the position of the particle at time t₀+t or t₀ and the angled brackets denote ensemble averaging. As well as these simulations, we also calculated the diffusion coefficient of K⁺ in an unconfined box of water molecules (bulk), in order to validate the employed parameters. In this case, the simulation box was cubic, with a side length of 7.5 nm and the simulation was run for 10 ns, using only the final 9 ns in the calculation of D. In the unconfined system, we obtained D=1.60×10⁻⁵ cm² s⁻¹, which agrees reasonably well with the experimental bulk diffusion coefficient of 1.96×10⁻⁵ cm² s⁻²³. This shows that our choice of interaction parameters for both the water and K⁺ ions produce diffusive results in reasonable agreement with experiment, despite dynamic properties not featuring in the original parameterization of the ion—water intermolecular potential.

In the channel, D is reduced relative to the bulk simulation (see FIG. 10). The difference in diffusion coefficient between bulk and the 9 to 11 Å channel is due to the limited diffusion perpendicular to the graphene sheets. Once the interlayer spacing is reduced below 9 Å, diffusion of K⁺ is further reduced relative to the bulk; K⁺ is only able to move within the plane of the single water monolayer at these interlayer spacings. Despite this, the calculated diffusion coefficients in sub-nm channels are in the same order of magnitude as in the bulk and rules out the diffusion limited ion permeation in sub-nm graphene channels.

In conclusion, we have demonstrated the possibility to control the interlayer spacing in GO membranes in the range below 10 Å. In this regime the capillary size is smaller than hydrated diameters of ions and their permeation is exponentially suppressed with decreasing d. The suppression mechanism can be described in terms of additional energy barriers that arise because of the necessity to partially strip ions from their hydrated shells so that they can fit inside the capillaries. Water transport is much less affected by d.

1. A water filtration membrane, said membrane comprising a graphene oxide (GO) laminate comprising a plurality of graphene oxide flakes, the planes of which are orientated parallel to one another; said GO laminate having a first pair of oppositely disposed faces which are oriented parallel to the planes of the plurality of graphene oxide flakes, said GO laminate also having a second pair of oppositely disposed faces which are oriented perpendicular to the planes of the plurality of graphene oxide flakes and a third pair of oppositely disposed faces which are oriented perpendicular to the planes of the plurality of graphene oxide flakes; wherein the GO laminate membrane is enclosed by a first encapsulating material that covers each of the first pair of faces of the GO laminate and each of the second pair of oppositely disposed faces of the GO laminate and wherein the third pair of oppositely disposed faces are either not enclosed or are enclosed by a second encapsulating material, said second encapsulating material being porous.

2. A membrane of claim 1, wherein the first encapsulating material is a polymer.

3. A membrane of claim 2, wherein the polymer has a water absorption of about 1.5% or lower after 30 days at 20° C.

4. A membrane of claim 2 or claim 3, wherein the polymer is formed from a resin having a viscosity of about 10 Pa.S or lower.

5. A membrane of claim 1, wherein the first encapsulating material is a metal or metal oxide.

6. A membrane of any preceding claim, wherein the first encapsulating material has a tensile strength of about 30 mPa or greater.

7. A membrane of any preceding claim, wherein the membrane also comprises graphene flakes, distributed through the graphene oxide flakes.

8. A membrane of any preceding claim, wherein the graphene oxide flakes of which the GO laminate is comprised have an average oxygen:carbon weight ratio in the range of from 0.2:1.0 to 0.5:1.0.

9. A membrane of any preceding claim, wherein the third pair of oppositely disposed faces are enclosed by a second encapsulating material that is porous.

10. A membrane of any one of claims 1 to 8, wherein the third pair of oppositely disposed faces are not enclosed

11. A membrane of any preceding claim, wherein the d-spacing of the hydrated graphene oxide laminate is in the range from 6 Å to 10 Å.

12. A membrane of claim 11, wherein the d-spacing of the hydrated graphene oxide laminate is 9 Å or below.

13. A membrane of claim 12, wherein the d-spacing of the hydrated graphene oxide laminate is 8 Å or below.

14. A membrane of claim 13, wherein the d-spacing of the hydrated graphene oxide laminate is 7 Å or below.

15. A method of reducing the amount of one or more solutes in an aqueous mixture to produce a liquid depleted in said solutes, the method comprising:
a) contacting a first face of the third pair of faces of the GO laminate of a water filtration membrane of any one of claims 1 to 14 with the aqueous mixture comprising the one or more solutes;
b) recovering the liquid depleted in said solutes from or downstream from a second face of the third pair of faces of the GO laminate and/or recovering a liquid enriched in said solutes from or downstream from the first face of the third pair of faces of the GO laminate.

16. A method of claim 15, wherein the method is a process of selectively reducing the amount of a first set of one or more solutes in an aqueous mixture without significantly reducing the amount of a second set of one or more solutes in the aqueous mixture to produce a liquid depleted in said first set of solutes but not depleted in said second set of solutes.

17. A method of claim 16, wherein the method is a method of removing NaCl from water.

18. A filtration device comprising a membrane of any one of claims 1 to 14.

19. A method of producing a membrane of any one of claims 1 to 14, the method comprising:
a) providing a graphene oxide (GO) laminate;
b) subjecting the GO laminate to an atmosphere having a predetermined relative humidity; and
c) enclosing each of the first pair and second pair of faces of the GO laminate membrane with the first encapsulating material while maintaining the relative humidity of the atmosphere at the predetermined level to provide the membrane of any one of claims 1 to 13.

20. A method of claim 19, wherein step (c) may comprise enclosing all six faces of the GO laminate with the first encapsulating material while maintaining the relative humidity of the atmosphere at the predetermined level; and subsequently removing the first encapsulation material from each of the third pair of faces to provide the membrane of any one of claims 1 to 14.

21. A method of claim 19 or claim 20, wherein the membrane is a membrane of claim 10 and wherein the relative humidity is less than 84%.

22. A method of claim 19 or claim 20, wherein the membrane is a membrane of claim 11 and wherein the relative humidity is less than 33%.

23. A method of claim 19 or claim 20, wherein the membrane is a membrane of claim 12 and wherein the humidity is less than 5%.
